(19) United States
(12) Patent Application Publication
(10) Pub. No.: US 2016/0010003 A1
(43) Pub. Date: Jan. 14, 2016

(54) METHOD AND APPARATUS FOR UPGRADING A HYDROCARBON

(71) Applicant: Industrial Process Technologies (Pty) Ltd, New South Wales (AU)

(72) Inventors: Michiel David Walters, New South Wales (AU); Matthew Richard Crooks, New South Wales (AU); Lawrence Keith Ambrose, New South Wales (AU); Bevan Dooley, New South Wales (AU); John David Winter, New South Wales (AU)

(73) Assignee: Industrial Process Technologies (Pty) Ltd, New South Wales (AU)

(21) Appl. No.: 14/771,790

(22) PCT Filed: Feb. 28, 2014
(86) PCT No.: PCT/AU2014/000190

§ 371 Date: Aug. 31, 2015

(30) Foreign Application Priority Data
Mar. 1, 2013 (ZA) 2013/01570

(51) Int. Cl. C10G 31/08; B01D 3/00; C10G 31/06

(52) U.S. Cl. CPC C10G 31/08; C10G 31/06; B01D 3/007

(57) ABSTRACT

A method and apparatus is described for removing at least some contaminants from a hydrocarbon feedstock, such as a petroleum. The method includes treating the contaminated feedstock during flow through a supercritical reactor with supercritical water to facilitate the removal of at least some of the contaminants. The flow through the supercritical reactor is a continuous flow.

This application claims priority from ZA2013/01570 filed on 1 Mar. 2013 and entitled: Used Oil Recycling Using Supercritical Water, which is hereby incorporated in its entirety by reference.

### TECHNICAL FIELD

This invention relates to the upgrading of a contaminated hydrocarbon, in particular a contaminated petroleum feedstock. In particular, the invention relates to the upgrading of a petroleum feedstock using supercritical water.

### BACKGROUND ART

Petroleum is a term that covers naturally unprocessed crude oils and petroleum products made up of crude oils. Crude oils can form other oils, for example, lubricating base oils can be derived from crude oil.

Hydrocarbons, such as petroleum, can be contaminated with materials including particles, metals or other, which can mean that the hydrocarbon is unsuitable for use in some application. The contamination can be present in the hydrocarbon naturally, and will therefore be present in the hydrocarbon resource following mining or extraction of it from e.g. underground. Alternatively, the contamination can be present as a result of additives added to the hydrocarbon during a use of the hydrocarbon in industry. Additives are added e.g. to a lubricating oil to improve the properties of the oil. It may be desirable to remove these additives following use of the oil. A major obstacle to the re-use of used oil is the presence of ash-forming impurities dispersed in the oil. Materials that contribute to the ash content of the oil include sub-micron size carbon particles, inorganic materials such as atmospheric dust, metal particles, lead, zinc, barium, calcium, phosphorus and iron. The presence of these ash-forming components in used oil places a limit on the extent to which it can be used economically and without ecological damage. For example, the re-use of used oil as fuel oil can give rise to serious atmospheric pollution if the oil contains in excess of one percent lead. Also, such fuel oil often results in additional burner and refractory maintenance costs that offset the purchase price differential between used oil and regular furnace oil.

Used oils and other petroleum byproducts are generated by many industries including, factories, motor vehicles, transport and shipping. Used oils are regulated as hazardous waste in all of the economically developed nations and the collection, treatment and disposal of used lubrication oil is carefully regulated. Incineration in power plants and industrial boilers is commonly used as a disposal method, but the high concentration of metals in most used lubrication oils can lead to the emission of noxious flue gas during incineration. The typically high sulphur levels in used lubrication oil can also lead to serious corrosion problems in the flue gases.

The disposal of used oil constitutes disposal of a non-renewable resource and with ever decreasing petroleum reserves, it is essential that used oil be recycled and re-used.

The preferred method of addressing the problem is to recycle the used lubrication oil to base oil, normally by means of a hydrogenation process. However, in current recycling methods, the metal contaminants cause problems in the hydrogenation process due to catalyst poisoning.

Current used lubrication oil de-ashing and recycling technologies make use of thermal distillation or propane solvent extraction processes, acid treatment or absorption of impurities by an appropriate medium such as bleaching clay. All these methods have inherent problems such as low yield, the generation of hydrogen sulphide, the handling of highly flammable gases at high pressure or the disposal of waste acid streams or spent bleaching medium which is itself saturated with used oil.

### SUMMARY OF THE DISCLOSURE

According to a first aspect of the invention there is provided a continuous method for removing at least some contaminants from a hydrocarbon feedstock, the method comprising the steps of:

passing a flow of a contaminated hydrocarbon feedstock into a supercritical reactor;

treating the feedstock during flow through the supercritical reactor with supercritical water to facilitate the removal of at least some contaminants thereby providing a treated feedstock;

allowing the treated feedstock to pass out of the supercritical reactor and into a pressure let down system;

wherein the flow through the supercritical reactor is a continuous flow.

In an embodiment, the continuous method also includes the step of removing contaminants from the treated feedstock.

According to a second aspect of the invention there is provided an apparatus for upgrading a hydrocarbon feedstock, the apparatus comprising:
(i) a supercritical reactor for receiving a continuous flow of a
   mixture of water and a contaminated hydrocarbon feedstock, the reactor having:
      at least one inlet for receiving water and the contaminated hydrocarbon feedstock;
      apparatus to pressurise and heat the mixture in the supercritical reactor to a temperature and pressure at or above the supercritical temperature and pressure of water, the supercritical water facilitating the removal of at least some contaminants thereby providing a treated feedstock;
      an outlet from which the treated feedstock exits the reactor, and
(ii) a pressure let down system for receiving the treated feedstock after exiting the supercritical reactor;
wherein the flow through the supercritical reactor is a continuous flow.

The invention provides a process and apparatus for the continuous processing of a hydrocarbon feedstock, such as a used lubrication oil, to remove at least some contaminants that may inhibit further processing of the hydrocarbon or that may limit the application of the hydrocarbon in industry.

The process is based on subjecting the hydrocarbon to supercritical water for a period of time sufficient to allow the supercritical water to break bonds between at least some of the contaminants and the hydrocarbon, thereby allowing the contaminants to be removed from the bulk. There may be other contaminants in the hydrocarbon which can be removed by physical separation or by the addition of the chemicals to the hydrocarbon feedstock.

The reaction process is undertaken on a continuous flow of feedstock through the supercritical reactor. By “continuous flow” it is meant that during use of the supercritical reactor (sometimes referred to as just a reactor) the feedstock is continuously fed into an inlet of the reactor, and during treatment, the feedstock continuously flows through the supercritical reactor. After treatment with supercritical water, the treated feedstock is continuously removed from the supercritical reactor.

In a continuous process, retention of the feedstock/water mixture as it flows through the supercritical reactor can be achieved by selecting the reactor length and/or the flow velocity of the feedstock/water mixture passing therethrough. The residence time of the mixture within the reactor can be commensurate with a predetermined reaction period.

In order that the process can be continuous, there can be a pump arrangement at an inlet and a valve arrangement at an outlet of the supercritical reactor. The feedstock is fed into the supercritical reactor via the inlet. The treated feedstock is removed from the supercritical reactor via the outlet.

The process of the present invention is not a batch process. In a batch process, a first volume of feedstock is passed into a supercritical reactor and the reactor is then sealed. The treatment of the batch of feedstock within the supercritical reactor is undertaken on a defined volume. In a batch process, during treatment, there is no inflow or outflow of feedstock from the supercritical reactor. Once the treatment of the feedstock is complete in a batch process, the outlet is opened and the batch is removed.

The feedstock fed into the reactor is a hydrocarbon. The hydrocarbon can be from a plant source, a renewable source or a fossil source. In one embodiment, the hydrocarbon is a petroleum. The hydrocarbon may be a lubricating oil, transformer oil or a mixture of used oils. The hydrocarbon may be a crude oil, topped crude oil, liquefied coal, a residue or product stream from a hydrocarbon refinery, a product stream from a steam cracker, or a liquid product recovered from oil sand, bitumen or asphaltene. The hydrocarbon may a vegetable oil or a bio oil from a pyrolysis process.

The hydrocarbon feedstock can be an unused feedstock. An unused hydrocarbon feedstock can have been recovered directly from a natural hydrocarbon source, e.g. an underground reservoir. Alternatively, a used hydrocarbon feedstock can be subject to the process. A used feedstock may have served in industry e.g. as a lubricating oil in an engine, a cooling fluid and/or as a hydraulic oil.

An unused mined hydrocarbon may comprise contaminants. Alternatively, the use of the hydrocarbon may have resulted in its contamination with contaminants.

The contaminants can include particles. The particles can be micron and/or sub-micron sized particles. The particles can be organic particles. The organic particles can be carbon particles. The particles can be inorganic particles. The inorganic particles can comprise atmospheric dust, non-metallic or metal particles. The metal particle contaminants can include lead, zinc, barium, molybdenum, calcium, and/or iron. The non-metallic particle contaminants can include phosphorus and/or sulphur.

Some of the contaminants in the hydrocarbon can be removed by a pre-treatment step. Thus, before being delivered to the reactor, the contaminated hydrocarbon feedstock may be pre-treated. The pre-treatment can be a first stage of the process. The pre-treatment may be to remove coarse impurities from the feedstock. The pre-treatment may include a physical separation of impurities. The pre-treatment may include filtration. The filtration may include passing the feedstock through a membrane, a centrifuge and/or passing the feedstock into a settling tank or stationary plate separator. Settling tanks and stationery plate separators may be used to remove free solids, but are not preferred due to the required time for settling. The pre-treatment may also include a chemical separation of contaminants or impurities. The chemical separation may include precipitation of contaminants from the feedstock. The pre-treatment may include an aqueous washing step. The washing step may remove reactive or corrosive compounds from the hydrocarbon feedstock. The reactive or corrosive compounds may be alkaline metal compounds. The reactive or corrosive compounds may be chlorine compounds. The removal of these corrosive materials can be advantageous because it may reduce subsequent corrosion of the internal surfaces of the reactor.

The hydrocarbon feedstock (optionally pretreated) is fed into an inlet of the supercritical reactor. The feedstock is preferably fed by a pump. The pump may be a high pressure pump. There may be a boost pump to further assist the high pressure pump to increase the pressure of the feedstock fed into the reactor. There may be a non-return value at the inlet of the reactor to prevent or reduce backflow of the feedstock. The feedstock can be heated and pressurized prior to delivery into the supercritical reactor.

The feedstock can be delivered to the supercritical reactor together with water. The water may be present in the feedstock naturally e.g. in the case of watery oils, or because of an earlier intentional addition of water. Alternatively, the feedstock can be mixed with water inside the supercritical reactor. The water is delivered from any available source. In one embodiment, the water is delivered from a separate tank which has an outlet in fluid communication with the flow path of the feedstock. The hydrocarbon feedstock is mixed with the water. There can be agitation to assist in the mixing. The agitation to mix the feedstock and water can be by mechanical stirring and/or sonication.

The hydrocarbon and water are present in the reactor in a ratio (water:hydrocarbon) of at least about 0.1:1, 1:1, 2:1, 3:1, 4:1 or 5:1, 10:1.

There must be enough water in the feedstock to allow the formation of supercritical water for reaction. If there is too much water in the feedstock/water mixture the process can become uneconomical. In one embodiment, the water:hydrocarbon ratio is in the range of about 1:1 to 5:1, preferably 1:1 to 2:1 (water:hydrocarbon).

The conditions within the supercritical reactor are controlled in order to form supercritical water. A supercritical fluid is any substance at a temperature and pressure above its critical point, where distinct liquid and gas phases do not exist. A supercritical fluid can effuse through solids like a gas and dissolve materials like a liquid. Supercritical fluids can be used as a substitute for organic solvents in a range of industrial and laboratory processes.

The mixture in the reactor is heated and pressurized to a temperature and pressure at or above the supercritical temperature and pressure of water.

The pressure of the supercritical reactor can be increased to at least about 22 MPa, 22.1 MPa, 24 MPa, 25 MPa, 30 MPa or 35 MPa. The pressure is increased independently of temperature and can be a step change effected by the pump. The pressure can be maintained in the reactor at a steady state for reaction. The temperature of the mixture in the reactor can be increased to at least about 350° C., 374° C., 375° C., 440° C. or 450° C. The temperature is controlled independently of pressure. The temperature can be increased by heat exchange. The temperature can be maintained at a steady state for reaction.

In one embodiment, the supercritical reactor is a continuous tube that is heated. The heat can be by direct gas firing, electrical heating or oil heating. In one embodiment, the supercritical reactor is a continuous tube immersed in a fluidised bed which is heated directly with combustion gases. The at least one tube of the supercritical reactor can be heated by means of a fluidised mineral sand bed. Hot combustion gas derived from a burner in the reactor plenum can be distributed by tuyeres into the sand to create and maintain the fluidised bed. The at least one tube of the supercritical reactor is preferably coiled and submerged within the fluidised bed, which acts as a heat transfer medium, providing even heating of the tube(s). The at least one tube is preferably formed from a heat conducting medium. In one embodiment, the at least one tube is formed from metal.

The feedstock/water mixture is pumped continuously through the at least one tube of the supercritical reactor. The feedstock and supercritical water are allowed to contact one another for a period of time sufficient for a reaction to occur. The reaction that occurs is a breaking of bonds between contaminants in the feedstock and the hydrocarbon material. The breaking of bonds may cause at least some of the contaminants to decrease in solubility in the feedstock. The breaking of bonds may cause at least some of the contaminants to become insoluble particles. The removal of at least some of the contaminants from the feedstock occurs at a later stage. The amount of time that the feedstock/water mixture remains in the reactor depends upon flow rate. The slower the flow rate the longer the mixture is in the reactor. The faster the flow rate the shorter the time period the mixture is in the reactor. The pressure letdown system at the outlet of the reactor can be used to control the flow rate. The reaction time is the time the mixture spends in the reactor. The reaction time can be pre-determined by trial and error on a given feedstock. The skilled person can undertake testing of a new feedstock e.g. by trialing different flow rates and by undertaking laboratory analysis on the treated feedstock removed from the reactor to determine optimal residence time.

The duration of the reaction time in the reactor can be selected to facilitate the reduction of the total amount of contamination in the feedstock by at least about 50, 60, 70, 80, 90 or 98, 99 or 100%. The reaction time can be selected to facilitate the reduction of metal contamination by 50, 60, 70, 80, 90 or 98, 99 or 100%. Supercritical fluids have solvent powers similar to liquid but the viscosity of the supercritical fluid is substantially lower than the parent fluid while the supercritical fluid density is many times greater than the parent fluid vapour phase at room temperature. Consequently molecular interactions occur at a much faster kinetic rate. In one embodiment, the mixture is allowed to react in the supercritical reactor at elevated temperature and pressure for a period of at least about 1, 2, 3, 5, 7, 10, 15, 20 or 30 minutes.

The flow through the reactor can be a plug flow. There is no or limited back mixing assumed with “plugs” of fluid passing through the reactor. In a plug flow, there is assumed to be no stagnant pockets of feedstock within the reactor and no gross by-passing or short-cutting of fluid flow within the reactor.

The reaction in the supercritical reactor can form off-gas by-products. In some embodiments, the off-gas by-products exiting from the reactor may be combusted in a heat exchanger to preheat the combustion air to increase the temperature of the supercritical reactor. This allows for the conservation of energy.

The treated feedstock flows from the outlet of the reactor and is subsequently cooled and the pressure reduces. In one embodiment, there is a step of extracting the mixture from the reactor and cooling the mixture to a temperature in the range of from about 80° C. to about 150° C. and reducing the pressure of the mixture to atmospheric pressure (101 kPa).

The treated feedstock from the supercritical reactor is delivered to a system. The system can be a pressure let down system in which the treated feedstock is de-pressurised and cooled, with steam being flashed off as required. The pressure letdown system may operate in accordance with any one of a number of techniques, such as pressure reducing valves, capillary tubes or hydraulic piston and cylinder arrangements. In one embodiment, the pressure let down system produces electricity as a supplementary process benefit. The pressure let down system allows the process to run continuously.

The high-pressure, high-temperature treated feedstock enters the pressure letdown system downstream of the supercritical reactor, and can subsequently undergo a temperature reduction phase, followed by a pressure reduction phase. Since high-pressure valves and seals are often susceptible to failure when operating at elevated temperatures, the temperature reduction phase can draw the temperature of the fluid down to a safe operating temperature for the materials of construction and other equipment used for the pressure letdown phase.

In one embodiment, once extracted from the supercritical reactor the treated feedstock/water mixture (sometimes referred to as just treated feedstock) is recirculated back to a heat exchanger where heat energy is recovered. In this embodiment, the high-pressure mixture can be cooled and the heat of the mixture used to reheat lower-pressure, outgoing hydrocarbon feedstock prior to that lower-pressure feedstock entering the evaporation stage. This recycling of the treated feedstock/water mixture can conserve energy.

Upon exiting the pressure letdown system, the treated feedstock can be separated into hydrocarbon, water and solids fractions. The solid fractions can comprise the contaminants. The separation can be by any means available. The treated feedstock can undergo evaporation to remove water and/or light hydrocarbon fractions. To ensure evaporation is rapid, the depressurized, cooled treated feedstock may undergo a reheating phase after the pressure reduction phase. In one embodiment, the separation is by vacuum evaporation. During evaporation, at least a part of the water and light hydrocarbon fraction can be removed, which can cause the insoluble metal contaminants to form flocculates and/or agglomerates. The flocs and/or agglomerated particles can then be separated from the treated feedstock. The separation can be by filtration or by gravity or by accelerated gravity separation.

The process may further include the steps of evaporating and condensing the water fractions to allow recycling and reuse of the water.

The apparatus of the invention may also include a means to cool and reduce the pressure of the mixture once it has been extracted from the supercritical reactor. There may also be a means for separating reactor product into hydrocarbon, water and solids fractions.

In certain embodiments, the treated feedstock has at least one of a higher (American Petroleum Institute) API gravity, higher middle distillate yield, lower content of sulfur containing compounds, lower content of nitrogen compounds, or lower content of metal (and/or non-metal) containing compounds. The final product can be a de-ashed hydrocarbon that is suitable for use as e.g. a marine diesel fuel or as a feed for a further refinement process such as hydrogenation, for instance, to produce base oil.

The process is particularly advantageous in that the processed used hydrocarbon exits the process with a significant reduction in contaminants compared to present methods. In advantageous embodiments, no dangerous chemicals are involved in the processing of the hydrocarbon.

Energy recovery from the process is also possible, reducing the overall energy requirement. The energy required to heat the water mixture to supercritical conditions may also be derived from the combustion of light end hydrocarbons liberated from the used lubrication oil during the process.

### BRIEF DESCRIPTION OF THE DRAWINGS

Notwithstanding any other forms which may fall within the scope of the invention as set forth in the summary, specific embodiments will now be described, by way of example only, with reference to the accompanying drawings in which:

FIG. 1 is a process flow diagram illustrating, diagrammatically, a process and apparatus configured for practicing the method of an embodiment of the present invention; and

FIG. 2 is a process flow diagram illustrating, diagrammatically, the process and apparatus of FIG. 1 with additional treatment sub-processes.

FIG. 3 a process flow diagram illustrating, diagrammatically, a process and apparatus configured for practicing the method of another embodiment of the present invention.

FIG. 4 a process flow diagram illustrating, diagrammatically, the process and apparatus used downstream of the reactor.

### DETAILED DESCRIPTION OF SPECIFIC EMBODIMENTS

In the following description, the process and apparatus are described in relation to used lubricating oil, but it should be understood that the invention is not limited to used lubricating oils and can be applied to any hydrocarbon comprising contamination.

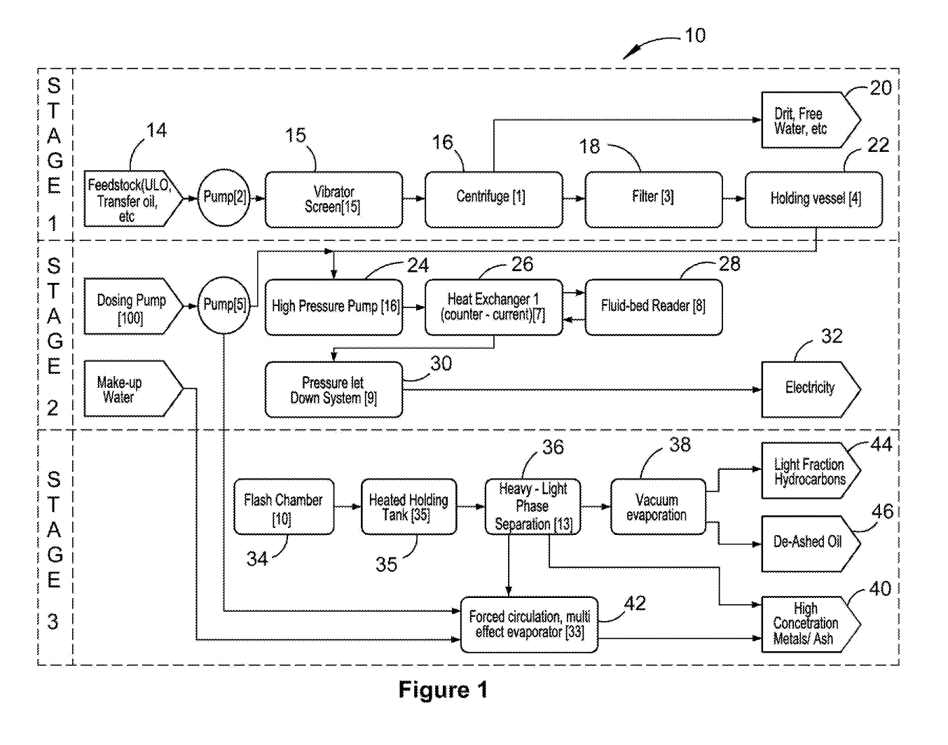

In the first stage of the process 10 illustrated in FIG. 1, a used hydrocarbon feedstock 14 constituted by used lubrication oil, transformer oil or the like is first subjected to a pre-treatment for coarse solids separation. The feedstock is heated to 80° C. to aid the separation process. Various chemicals are added by means of a chemical dosing pump to facilitate faster or even more complete removal of the chemical impurities or to break up emulsions in the hydrocarbon feedstock, such as free radical scavengers and pH adjustment chemicals.

The preferred separation method is to first screen the hydrocarbon feedstock by means of a vibratory screen 15 to remove particulate and fibrous material larger than 100 μm. The feedstock 14 is then pumped through a centrifuge 16 to remove particles larger than 1 μm and then through a filter 18 to remove particles less than 1 μm. The bulk solids exiting the centrifuge are disposed of to waste 20 and the filtered feedstock is stored in a holding and mixing vessel 22.

In the second stage of the process, the hydrocarbon feedstock is mixed with water in a ratio of 2:1 (water:oil by mass). The mixture is pumped to a pressure head of about 400 kPa and supplied to a high pressure pump 24. Additional chemicals and catalysts may be dosed into the mixture to aid with de-ashing.

The high pressure pump 24 increases the pressure of the feedstock/water mixture to 24 MPa. The high pressure pump 24 supplies the feedstock/water mixture to a countercurrent heat exchanger 26 in which the mixture is preheated, entering at ambient temperature and exiting at a temperature in the range of from about 275° C. to about 320° C.

From the beat exchanger 26 the feedstock/water mixture is fed into a supercritical reactor 28. The reactor 28 is a continuous metal tube/fluidised bed supercritical reactor in which the tube is heated by means of a fluidised mineral sand bed. The feedstock/water mixture is pumped continuously through the single length of tubing which forms a plug flow reactor with good residence time control. To increase process capacity, the tube is arranged in a coil. Multiple coils are used to increase capacity. The fluidised bed reactor heats the feedstock/water mixture to a reaction temperature in the range of from about 350° C. to about 450° C. and preferably about 400° C. In the reactor 28, the mixture is retained, during plug flow through the reactor tube, at the preset temperature and pressure for a mean residence time of 10 minutes.

The reacted feedstock/water mixture exits the supercritical reactor 28 after the established residence time and, from the reactor 28 the treated feedstock/water mixture recirculates back in countercurrent flow direction to heat exchanger 26 where heat energy is recovered from the treated mixture, the mixture itself being cooled and the heat from the mixture heating the incoming hydrocarbon feedstock entering the heat exchanger 26. The treated feedstock/water mixture exits the heat exchanger 26 at about 140° C.

In the third and final stage of the process 10, the treated feedstock/water mixture undergoes pressure let down through a pressure let-down system 30 in which the mixture is de-pressurised to atmospheric pressure and cooled to just below 100° C., with steam being flashed off as required. The pressure letdown system 30 may comprise capillary tubes or hydraulic piston and cylinder arrangements.

In one embodiment, the treated hydrocarbon exiting the reactor via the pressure let down system is fed to a flash tank 34 and then to a heated holding vessel 35 in which the treated fluid is held at an elevated temperature in the range of from about 80° C. to about 90° C. From there the treated fluid is fed to a centrifuge 36 where the treated fluid is separated into heavier and lighter phases. From the centrifuge 36, the lighter phase, which now constitutes a near final oil product, is sent to a vacuum evaporation arrangement 38. The heavier centrifuge phase is made up of excess water, eluted solids and other impurities. The eluted solids and other impurities are discharged as an essentially solids phase which is removed directly to waste 40. The liquid centrifuge phase (excess water with some solids content) is fed to a forced circulation, multi effect evaporator 42. The products of the evaporator 42 are demineralised water, which is recycled back to the high pressure pump 24, and a final solids phase, which is disposed of to waste 40. In the vacuum evaporation arrangement 38, trace water and light-end hydrocarbons 44 are removed from the near final oil product to yield a final solid product comprising contaminants that is stored in a final product vessel 46. The light fraction hydrocarbons and noxious gases may be captured and afterburnt in the fluidised bed plenum of the supercritical water reactor 28 to reduce stack emissions, recover the energy value and minimise fugitive emissions.

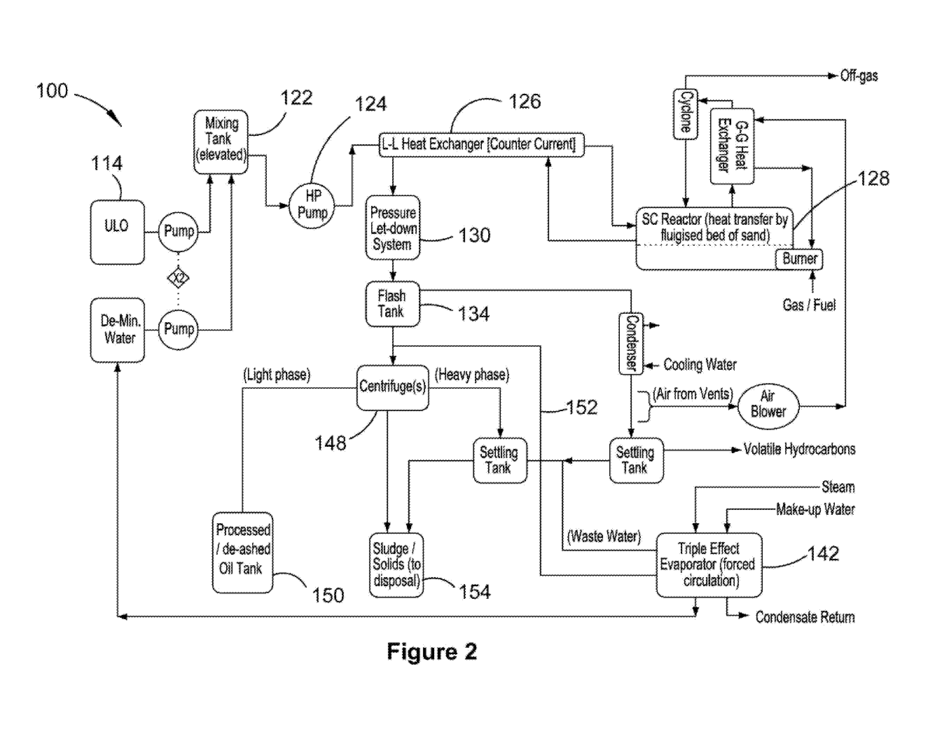

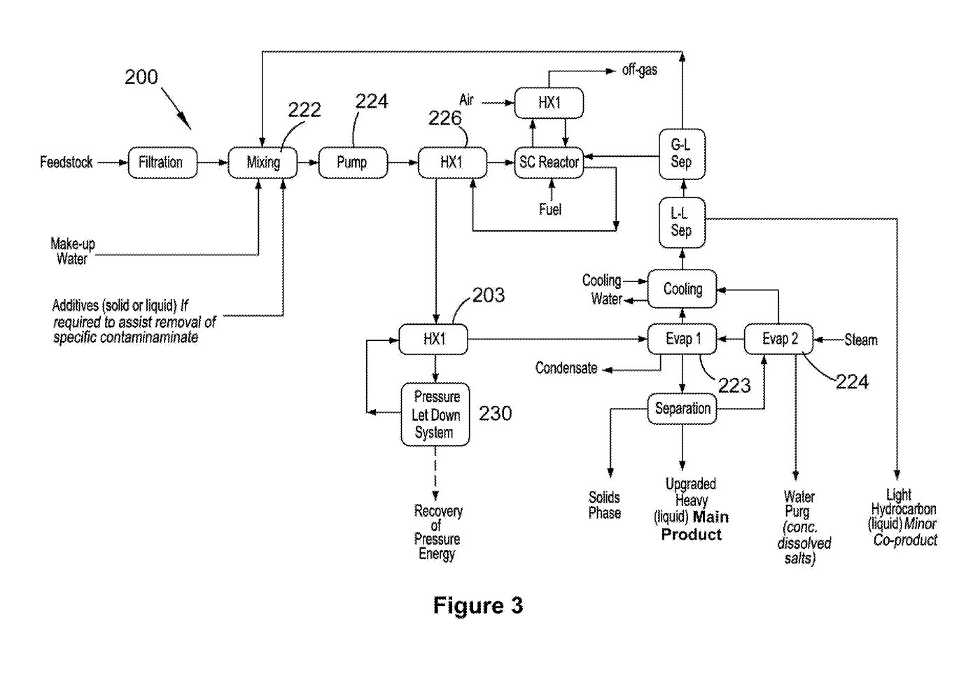

The more detailed processes illustrated in FIGS. 2 and 3 make use of similar process apparatus as that illustrated in FIG. 1 and similar items of equipment are similarly numbered.

In the FIG. 2 process 100, the cooled, depressurised treated feedstock is held in a combination flash tank and heated holding tank 134 to a temperature in the range of from about 80° C. to about 90° C. and then passed through a primary stacked disk centrifuge 148 in which the treated feedstock is separated into three streams: de-ashed oil (contaminants removed) 150; water 152; and concentrated coagulated solids 154. The de-ashed oil 150 may be further cleaned at 90° C. through a second stacked disk centrifuge setup as a purifier to further remove ash particles and water. After centrifuging the oil is dried. This further cleaning process is not shown in FIG. 2 since it is similar to that described with reference to FIG. 1. The de-ashed oil 150 is a suitable feed for hydrogenation to produce base oil. The water stream from the centrifuge 148 is passed through a forced circulation multi-effect evaporator 142 in which the treated water is recycled. The concentrated metals 154 from the centrifuge are considered waste and may be disposed along with the concentrated salts and solids from the water evaporator bottoms.

In FIG. 3 process 200, similar processes as shown in FIGS. 1 and 2 are shown. Evaporation steps 223 and 224 are shown. Evaporation step 223 comprises heating of the treated feedstock to remove at least some of the water and possibly some of the light hydrocarbon fraction from. The light hydrocarbon fraction can be recovered for use. The water can also be recovered. The water can be recirculated to the supercritical reactor and used as a source of supercritical water.

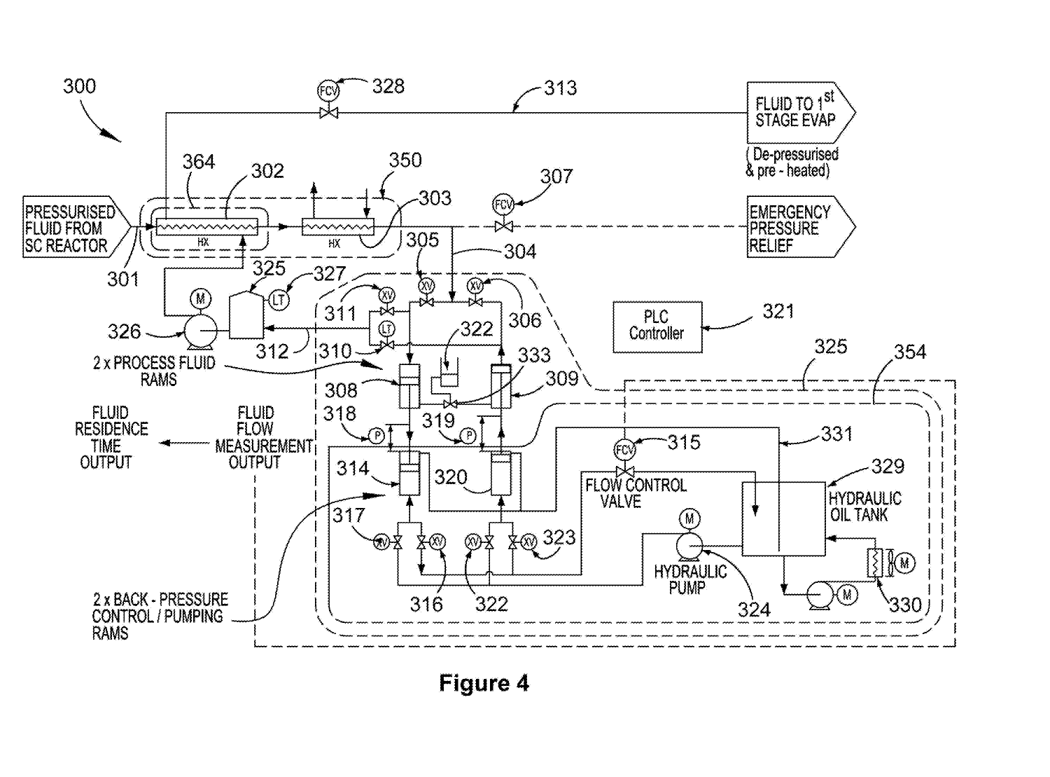

With reference to the embodiment shown in FIG. 4, high-pressure, high-temperature fluid flows from the supercritical reactor, through conduit 301, into the temperature reduction phase 350 of the pressure letdown system 330. The temperature reduction phase 350 comprises at least one heat exchanger, such as first heat exchanger 302, for extracting heat from the high-pressure, high-temperature fluid. First heat exchanger 302 may be a pinch heat exchanger as discussed below. First heat exchanger 302 lowers the temperature of the high-pressure, high-temperature fluid from an initial temperature to a first reduced temperature at or above an operating temperature range of the equipment used in the pressure letdown phase. For example: the temperature of the stream of fluid entering the first heat exchanger 302 from the supercritical reactor, along conduit 301, may be approximately 144° C.; the temperature of the stream of fluid exiting the first heat exchanger 302 to flow on to the second heat exchanger 303 may be approximately 80° C.; the temperature of the stream of fluid entering the first heat exchange 302 after depressurization (e.g. from surge tank 325 as discussed below) may be approximately 75° C.; and the temperature of the stream of fluid exiting the first heat exchanger 302 along conduit 313 may be approximately 120° C.

After exiting the first heat exchanger 302, the high-pressure, partially cooled fluid passes into a second heat exchanger 303. The second heat exchanger 303 is positioned in series with the first heat exchanger 302. The second heat exchanger 303 is a water-cooled heat exchanger. The second heat exchanger 303 further reduces the temperature of the high-pressure, partially cooled fluid from the first reduced temperature to a second reduced temperature. The second reduced temperature is within the operating temperature range of the equipment used in the pressure letdown phase 352. In some cases, the second heat exchanger 303 reduces the temperature of the fluid by approximately 5° C.

In the second heat exchanger 303 heat is transferred from the high-pressure, partially cooled fluid into the water used to cool the heat exchanger 303. The second heat exchanger 303 can therefore serve as a preheating device for preheating water for introduction into the hydrocarbon feedstock in advance of the feedstock entering the supercritical reactor 330. In some cases, the main duty of the second heat exchanger 303 will be to initiate cooling on start-up. For example, the second heat exchanger 303 may ensure the fluid reaches a safe operating temperature for the pressure reduction phase 352 for the period of time immediately after start-up and before the first heat exchanger 302 reaches steady state, or before the first ‘charge’ or part of the fluid flow has been depressurized and returned to the first heat exchanger 302 for reheating as discussed below.

It is desirable that, when in steady state operation, most or all of the heat extracted from fluid through the temperature reduction phase 350 is transferred to the depressurized fluid before it exits the pressure letdown system 30 to commence the evaporation stage. Thus, when in steady state operation most of the temperature reduction in the temperature reduction phase 350 occurs in the first heat exchanger 302, with comparatively little, or no, temperature reduction occurring in the second heat exchanger 303.

If one or more additional heat exchangers are provided downstream of the second heat exchanger 303, the output temperature of the second heat exchanger may be above the operating temperature range of the equipment used in the pressure letdown phase 352. The one or more additional heat exchangers (not shown) may progressively lower the temperature of the fluid to the operating temperature range of the equipment used in the pressure letdown phase 352. The one or more additional heat exchangers may be positioned in series with the first and second heat exchangers 302, 303.

The high-pressure, cooled fluid exits the temperature reduction phase through conduit 304 at a temperature within the operating temperature of the equipment of the pressure letdown phase 352. A pressure relief valve 307 is provided to relieve pressure in conduit 304 in the event of an overpressure.

The high-pressure, cooled fluid flowing through conduit 304 is selectively directed into cylinders 308, 309. High-pressure, cooled fluid is directed into only one cylinder 308, 309 at a time. Valves 305, 306 are provided to control the flow of high-pressure, cooled fluid into cylinders 308, 309. Valves 305, 306 are electronically operated by a controller 321 described below.

In typical use, valve 305 will be opened and valve 306 closed. High-pressure, cooled fluid flows through valve 305 into cylinder 308 to fill cylinder 308—thus cylinder 308 enters the ‘filling cycle’. Cylinder 308 is filled with a predetermined amount of fluid. The predetermined amount of fluid may be dependent on the desired pressure reduction to be achieved by cylinder 308. Once cylinder 308 has been filled with the predetermined amount of fluid, valve 305 is closed.

The high-pressure, cooled fluid bears against one side of a cylinder head 308′. After valve 305 is closed, pressure or force applied to the opposite side of the cylinder head 308′ is reduced. The high-pressure, cooled fluid pushes the cylinder head 308′ down, thereby increasing the volume of the cylinder 308 occupied by the fluid and reducing the pressure of the fluid.

Once the pressure has been reduced to the desired level in cylinder 308, valve 310 is opened. Cylinder 308 then enters a ‘discharge cycle’. During the discharge cycle pressure or force is applied to the opposite side of the cylinder head 308′ to pump depressurized, cooled fluid from the cylinder 308 through valve 310 and out of the pressure letdown phase 352.

During the filling cycle of cylinder 308, cylinder 309 undergoes its discharge cycle. Cylinder 309 completes its discharge cycle as cylinder 308 completes its filling cycle. After valve 305 is closed, valve 306 opens to enable a predetermined amount of high-pressure, cooled fluid to flow into cylinder 309. Once cylinder 309 has been filled with the predetermined amount of fluid, valve 306 is closed and valve 305 is opened. The high-pressure, cooled fluid bears against one side of a cylinder head 309′. After valve 306 is closed, pressure or force applied to the opposite side of the cylinder head 309′ is reduced. The high-pressure fluid pushes the cylinder head 309′ down, thereby increasing the volume of the cylinder 309 occupied by the fluid and reducing the pressure of the fluid.

Once the pressure has been reduced to the desired level in cylinder 309, valve 311 is opened. Cylinder 309 then enters its discharge cycle. During the discharge cycle pressure or force is applied to the opposite side of the cylinder head 309′ to pump fluid from the cylinder 309 through valve 311 and out of the pressure letdown phase 352.

Filling and discharge timing can be controlled by operation of valves 305, 306, 310 and 311, and operation of a backpressure system 354. Filling and discharge may be controlled so that high-pressure, cooled fluid is continuously flowing through conduit 304 into one of cylinders 308, 309. Filling and discharge may be controlled so that the discharge cycle for a cylinder 308, 309 is finished a predetermined period of time before the filling cycle commences for that cylinder 308, 309.

Backpressure system 354 controls the position of the piston heads 308′, 309′. Piston heads 308′, 309′ are directly coupled to backpressure rams 314, 320 respectively. Control of the pressure in the backpressure rams 314, 320 can therefore be used to indirectly control the pressure in cylinders 308, 309.

Backpressure rams 314, 320 are hydraulic rams fed with hydraulic fluid from an hydraulic fluid reservoir 329. In use, fluid is pumped from the reservoir by pump 324. Pump 324 may be a variable speed pump or operated at a set pressure with a bleed valve.

During the filling phase of cylinder 308, valve 316 is opened and valve 317 is closed. Hydraulic fluid flows out of backpressure ram 314 through valve 316 and along a return conduit 356 into the hydraulic fluid reservoir 329. Also during the filling phase of cylinder 308, cylinder 309 is discharging. Thus valve 322 is opened and valve 323 is closed. Hydraulic fluid is pumped from reservoir 329, along conduit 358, through valve 322 and into backpressure ram 320.

During the filling phase of cylinder 309, valve 323 is opened and valve 322 is closed. Hydraulic fluid flows out of backpressure ram 320 through valve 323 and along a return conduit 356 into the hydraulic fluid reservoir 329. Also during the filling phase of cylinder 309, cylinder 308 is discharging. Thus valve 317 is opened and valve 316 is closed. Hydraulic fluid is pumped from reservoir 329, along conduit 358, through valve 317 and into backpressure ram 314.

A control mechanism 315 is provided to control the rate of movement of cylinder heads 308′, 309′. Control mechanism 315 comprises a valve. The valve of control mechanism 315 is positioned in the return conduit 356. Control mechanism 315 is therefore controllable to govern the rate of discharge of hydraulic fluid from backpressure rams 314, 320. Controlling the rate of discharge of hydraulic fluid from backpressure rams 314, 320 controls the rate of movement of cylinders heads 308′, 309′. Controlling the rate of movement of cylinder heads 308′, 309′ determines the rate at which the high-pressure fluid is discharged. The rate at which the high-pressure fluid is discharged determines the time taken for the filling and discharge cycles. By controlling the time taken for filling and discharge, the control mechanism 315 controls the flow rate through the pressure letdown system 30.

If a particular rate of flow through pressure letdown system 330 is desired, a measurement device may be provided to measure the position of cylinder heads 308′, 309′ in cylinders 308, 309. The measurement device may comprise one or more linear position encoders 318, 319. Linear position encoders 318, 319 can determine a position of cylinder heads 308′, 309′. Cylinder heads 308′, 309′ are presently coupled to backpressure rams 314, 320 by connecting rods 360, 362, so the linear position encoders 318, 319 may determine the location of the connecting rods 360, 362 and thereby determine the position of the cylinder heads 308′, 309′.

The measurement device may supply measurement data to a system controller 321. The system controller 321 may include a programmable logic controller. The measurement data may be used by the system controller 321 to control operation of valve 315. The measurement data may also be used by the system controller 321 to control operation of other valves 305, 306, 310, 311, pumps 324, 326 and other components of the pressure letdown system 30 as necessary.

The measurement data can also be recorded so as to measure system throughput over time. In measuring the rate of flow through the pressure letdown system 30, the measurement data may also be used to determine residence time in the supercritical reactor.

To avoid overheating of the hydraulic fluid, a forced draft cooler 330 is provided on the hydraulic fluid reservoir 329. The forced draft cooler 330 may alternatively be provided on the return conduit 356. However, hydraulic fluid has a longer residence time in the reservoir 329 when compared with the return conduit 356. Thus hydraulic fluid in the reservoir 329 will be subject to cooling by the forced draft cooler for a longer period of time when compared with hydraulic fluid in the return conduit 356.

The hydraulic fluid may also be used to lubricate backpressure rams 314, 310. To this end a lubrication conduit 331 is provided. The lubrication conduit 331 conveys hydraulic fluid from the reservoir 329 to the backpressure rams 314, 320. Similarly, a lubricant can be supplied from a lubricant tank 332 to cylinder heads 308′, 309′.

In the event that cylinders 308, 309 or backpressure rams 314, 320 leak, a film of water or liquid may be observed on the surface of the hydraulic fluid in the reservoir 329. The reservoir 329 may therefore include a window for viewing the surface of the hydraulic fluid.

As discussed above, the discharge cycle can be timed to match the filling cycle. In some circumstances, it will be desirable to complete the discharge cycle of one cylinder 308, 309 in advance of the filling cycle of the other cylinder 308, 309. This will ensure that a cylinder is at all times available to commence the filling cycle. If a cylinder is not immediately available for filling, the pressure in the conduit 304 and backpressure upstream of the conduit may fluctuate. In the worst case, pressure fluctuations may progress back to the supercritical reactor.

In general, the discharge cycle should be finished sufficiently in advance of the filling cycle to enable closure of valve 310 or 311 before opening of valves 306 or 305 respectively. As a result of the filling cycle taking slightly longer than the discharge cycle, the flow rate into the cylinders 308, 309 during the filling cycle may be lower than the flow rate from the cylinders 308, 309 during the discharge cycle. To ensure the flow rate from the pressure letdown system 30 matches the flow rate into the pressure letdown system 30, a surge tank 325 is provided on conduit 312 into which cylinders 308, 309 discharge.

Depressurized, cooled treated feedstock is pumped from the surge tank 325 by pump 326, to the reheating phase 364. In the reheating phase 364 the depressurized, cooled treated feedstock enters the first heat exchanger 302. Heat is transferred from the inflowing high-pressure, high-temperature fluid into the depressurized, cooled fluid to heat the depressurized cooled fluid. The heat exchanger 302 may be a pinch heat exchanger where the temperature of the fluid flowing into the second heat exchanger 304 is approximately equal to the temperature of the depressurized fluid as it exits the reheating phase 364.

Once the treated feedstock exits the reheating phase it passes along conduit 313, through valve 328. Valve 328 is used to control flow of depressurized fluid through the first heat exchanger 302 and thereby control flow of depressurized fluid from the surge tank 325. The valve 328 operates based on the level of fluid in the surge tank 325. The level of fluid is the surge tank is measured by a measuring device 327. The measuring device 327 transmits a measurement indicative of the level of fluid in the surge tank 325 to the controller 321. The controller 321 then operates the valve 328 to control the flow rate through the valve 328 and thus the flow rate from the tank 325.

It will be appreciated that modifications to the pressure letdown system are envisaged, but only a single embodiments has been described for the purposes of illustration. All such modifications are intended to constitute part of the present disclosure. For example, cylinders in addition to cylinders 308 and 309 may be provided. Where a number n of cylinders is provided, the discharge cycle may take n times as long as the filling cycle. This will reduce the stresses on the equipment used in the pressure letdown phase 352. Valves used to control filling of the n cylinders may be controlled so that only a single cylinder is filling at any given time. Valves used to control discharge from the n cylinders may be controlled so that all cylinders, except the cylinder being filled, discharge concurrently. To enable concurrent discharge from multiple cylinders, it is desirable that the pressure of the fluid being discharged is consistent between the multiple cylinders.

A further modification would be to replace the backpressure rams 314, 320 with floating piston heads so that high-pressure cooled fluid hears against one side of the respective floating cylinder head, and hydraulic fluid from reservoir 329 bears against the opposite side. After passing through valve 328, the depressurized, reheated fluid flows along conduit 313 towards the evaporation stage.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

It is to be understood that, if any prior art publication is referred to herein, such reference does not constitute an admission that the publication forms a part of the common general knowledge in the art, in Australia or any other country.

1. A continuous method for removing at least some contaminants from a hydrocarbon feedstock, the method comprising the steps of:
passing a flow of a contaminated hydrocarbon feedstock into a supercritical reactor;
treating the feedstock during flow through the supercritical reactor with supercritical water to facilitate the removal of at least some contaminants thereby providing a treated feedstock;
allowing the treated feedstock to pass out of the supercritical reactor and into a pressure let down system;
wherein the flow through the supercritical reactor is a continuous flow.

2. The continuous method according to claim 1, wherein the method further includes the step of passing the treated feedstock to a heat exchanger where heat energy is recovered and the treated feedstock is cooled wherein at least some of the heat from the treated feedstock heats the incoming hydrocarbon feedstock prior to entering the supercritical reactor.

3. The continuous method according to claim 1, further including the step of removing contaminants from the treated feedstock to produce a final product.

4. The continuous method according to claim 1, wherein the method further includes the step of passing the treated feedstock to at least one evaporation stage to evaporate at least some of the water and/or light hydrocarbon fraction from the treated feedstock.

5. The continuous method according to claim 4, wherein the water and/or light hydrocarbon phase evaporated is condensed and recovered, and wherein at least some of the recovered water is used to treat feedstock during flow through the supercritical reactor.

6. (canceled)

7. The continuous method according to claim 1, wherein metal contamination in the hydrocarbon is reduced by at least about 80, 90, 98, 99 or 100% in the final product.

8. The continuous method according to claim 1, wherein the contaminants removed by the process include carbon particles, atmospheric dust, lead, zinc, barium, molybdenum, calcium, iron, phosphorus and/or sulphur.

9. (canceled)

10. The continuous method according to claim 1, wherein the hydrocarbon feedstock and water are present in the reactor in a ratio (water:hydrocarbon) of 1:1 to 2:1.

11. (canceled)

12. The continuous method according to claim 1, wherein the hydrocarbon is selected from a petroleum, a lubricating oil, a transformer oil, a crude oil, topped crude oil, liquefied coal, liquefied biomass, a product or residue stream from a hydrocarbon refinery, a product stream from a steam cracker, a liquid product recovered from oil sand, bitumen or asphaltene or mixtures thereof.

13. A hydrocarbon when upgraded by a continuous method according to claim 1.

14. An apparatus for upgrading a hydrocarbon feedstock, the apparatus comprising:
(i) a supercritical reactor for receiving a continuous flow of a mixture of water and a contaminated hydrocarbon feedstock, the reactor having:
at least one inlet for receiving water and the contaminated hydrocarbon feedstock;
apparatus to pressurize and heat the mixture in the supercritical reactor to a temperature and pressure at or above the supercritical temperature and pressure of water, the supercritical water facilitating the removal of at least some contaminants thereby providing a treated feedstock;
an outlet from which the treated feedstock exits the reactor; and
(ii) a pressure let down system for receiving the treated feedstock after exiting the supercritical reactor;
wherein the flow through the supercritical reactor is a continuous flow.

15. (canceled)

16. The apparatus according to claim 14, wherein the supercritical reactor comprises a continuous tube immersed in a fluidized bed, and wherein the continuous tube is coiled and submerged within the fluidized bed, which acts as a heat transfer medium, providing even heating of the tube.

17. The apparatus according to claim 14, comprising at least one heat exchanger, wherein the heat from the treated feedstock can be used to heat the contaminated feedstock fed to the inlet of the supercritical reactor.

18. The apparatus according to claim 14, wherein the apparatus is adapted to allow offgas generated during the reaction in the supercritical reactor to be recirculated to heat the supercritical reactor.

19. The apparatus according to claim 14, wherein the apparatus is connected to at least one evaporation arrangement and wherein treated feedstock exiting the pressure let down system is fed to the evaporation arrangement.

20. The apparatus according to claim 19, wherein water is evaporated from the treated feedstock in the evaporation arrangement and the apparatus is adapted to allow at least some of the recovered, evaporated water to be fed to the source of water in step (i).

21-38. (canceled)

39. A method for preparing a high-pressure, high-temperature fluid for evaporation, comprising:
reducing a temperature of the fluid;
reducing a pressure of the fluid; and
reheating the fluid.

40. A method according to claim 39, wherein the step of reducing a temperature comprises transferring heat from a first portion of the fluid into a second portion of the fluid undergoing the reheating step.

41. A method according to claim 39, further comprising the step of receiving the fluid from a supercritical reactor before performing the step of reducing a temperature.

42. A method according to claim 39, when performed using a system for reducing pressure in a high-pressure, high-temperature fluid, the system comprising:
a temperature reduction phase connected to a source of fluid; and
a pressure reduction phase for receiving fluid from the temperature reduction phase;
wherein the temperature reduction phase reduces a temperature of the fluid to an operating temperature of the pressure reduction phase:
wherein the step of reducing a temperature is performed by the temperature reduction phase, the step of reducing a pressure is performed by the pressure reduction phase, and the step of reheating is performed by the reheating phase.
